(19) United States
(12) Patent Application Publication
(10) Pub. No.: US 2003/0169653 A1
(43) Pub. Date: Sep. 11, 2003

(54) Apparatus and method for deleting noise

(75) Inventors: Chang-Yeob Choo, Gyeonggi-do (KR); Cho Jae Hoon, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD

(21) Appl. No.: 10/379,544

(22) Filed: Mar. 6, 2003

(30) Foreign Application Priority Data
Mar. 6, 2002 (KR) 2002-11870

(51) Int. Cl. G11B 7/095

(52) U.S. Cl. 369/44.32; 369/53.33

(57) ABSTRACT

Provided is an apparatus and a method of driving an optical disk, and more particularly, to an apparatus and a method of removing radial noise generated when an optical disk is reproduced. The apparatus removing noise in an optical recording medium driver provides a noise processor detecting an error signal from a high-frequency signal output by a pickup when the optical recording medium is reproduced, and removing noise included in the error signal and a second signal processor outputting a pickup motion signal moving the pickup by using the error signal from which noise is removed and which has been output from the noise processor. Through the apparatus and the method, it is possible to solve the problems of a focus drop in a focus servo, and a pickup lens which is confined to a right or left side in a tracking servo, by detecting and removing radial noise from the RF signals which are output from the optical disk.

### CROSS-REFERENCE TO RELATED APPLICATIONS

This application claims the benefit of Korean Patent Application No. 2002-11870, filed on Mar. 6, 2002, in the Korean Intellectual Property Office, the disclosure of which is incorporated herein by reference.

### BACKGROUND OF THE INVENTION

1. Field of the Invention

The present invention relates to an apparatus and a method of driving an optical disk and more particularly, to an apparatus and a method of deleting radial noise occurring when the optical disk is reproduced.

2. Description of the Related Art

FIG. 1 is a block diagram showing the configuration of a driving apparatus of a conventional optical disk. Radio Frequency (RF) signals, which are reflected from an optical disk 100 by a pickup 101, are amplified and processed in an RF amplifier 102 and output as tracking error and focus error signals. The tracking error and the focus error signals are input to a digital signal processor (DSP) 103. The DSP 103 processes the input tracking error and the focus error signals to control operations of a servo and outputs them as tracking actuator out (TAO) and focus actuator out (FAO) signals. A driver, using pulse width modulation (PWM), 104 outputs the TAO and FAO signals, which are used to move a pickup actuator 105.

When an optical disk 100 is reproduced, radial noise with a frequency of 500˜2500 Hz can occur due to damage on a track or a recording region of the optical disk 100. When radial noise with a high level and a low frequency is produced, and a servo follows signals having radial noise, a focus drop occurs in a focus servo, and a pickup lens is likely to be confined to a right or left side in a tracking servo. As the speed of the optical disk 100 increases, radial noise becomes larger than in an original signal. Thus, radial noise makes it difficult to control a servo.

### SUMMARY OF THE INVENTION

It is an aspect of the present invention to provide an apparatus detecting and deleting noise in RF signals which are output from an optical disk.

It is another aspect of the present invention to provide a method detecting and deleting noise in RF signals which are output from an optical disk.

In one aspect, the present invention provides an apparatus removing noise in a first optical recording medium driver, the apparatus comprising a noise processor detecting an error signal from a high-frequency signal output by a pickup when the optical recording medium is reproduced and removing noise included in the error signal, and a second signal processor outputting a pickup motion signal moving the pickup by using the error signal from which noise is removed and which has been output from the noise processor.

The noise processor according to the present invention may include a high-frequency amplifier amplifying the high-frequency signal that is output by a pickup when the optical recording medium is reproduced, a noise detector detecting a first error signal from the amplified high-frequency signal and determining if there is noise in the signal by comparing the first error signal with a reference value, and a noise remover turning on a noise removing switch if the first error signal is not equal to the reference value. The noise remover outputs a third error signal from which noise is removed by combining the first error signal with a second error signal. The second error signal is maintained at a reference voltage level when the switch-on signal is turned off and is an inversed first error signal when the switch is turned on. In other words, the third error signal follows the shape of the first error signal when the switch is off and the third error signal is null or maintained at a reference voltage when the switch is on. The noise detector and the noise remover do not operate if the pickup performs a seek or a jump operation.

In another aspect, the present invention provides an apparatus removing noise in an optical recording medium driver that includes an amplifier amplifying a high-frequency signal output by a pickup when an optical recording medium is reproduced, a noise processor detecting an error signal from the high-frequency signal output from the amplifier and removing noise included in the error signal, and a signal processor outputting a pickup motion signal moving the pickup by using an error signal from which noise is removed and which has been output from the noise processor.

The noise processor comprises a noise detector detecting the first error signal from the amplified high-frequency signal and determining if there is noise in the signal by comparing the detected first error signal with a reference value. The noise processor also includes a noise remover turning on a noise removing switch removing noise if the first error signal is not equal to a reference value and outputting a third error signal from which noise is removed by combining the first error signal with a second error signal. The second error signal is an inversed first error signal when the noise removing switch is turned on and is null when the noise removing switch is turned off. The noise detector and the noise remover do not operate if the pickup performs a seek or a jump operation.

In another aspect, the present invention provides a method removing noise while driving an optical recording medium, the method comprising detecting an error signal from a high-frequency signal output by a pickup when an optical recording medium is reproduced and removing noise included in the error signal and processing an error signal from which noise is removed into a pickup motion signal moving the pickup and outputting the processed signal.

Detecting the error signal and removing noise comprises amplifying the high-frequency signal output by the pickup when the optical recording medium is reproduced, detecting a first error signal from the amplified high-frequency signal and determining if there is noise in the first error signal by comparing the first error signal with the reference value, turning on a noise removing switch removing noise if the first error signal is not equal to a reference value and outputting a third error signal from which noise is removed, by combining the first error signal with a second error signal produced by an inversed first error signal when the noise removing switch is turned on and by outputting the first error signal when the noise removing switch is turned off. Detecting the first error signal, turning on the noise removing switch, and outputting the third error signal are not performed when the pickup performs a seek or a jump operation.

Additional aspects and advantages are set forth in the description below and/or are obvious from the description or may be learned by practicing the invention.

### BRIEF DESCRIPTION OF THE DRAWINGS

The above aspects and advantages of the present invention will become more apparent by describing in detail embodiments thereof with reference to the attached drawings in which:

FIG. 1 is a block diagram showing the configuration of an apparatus driving a conventional optical disk;

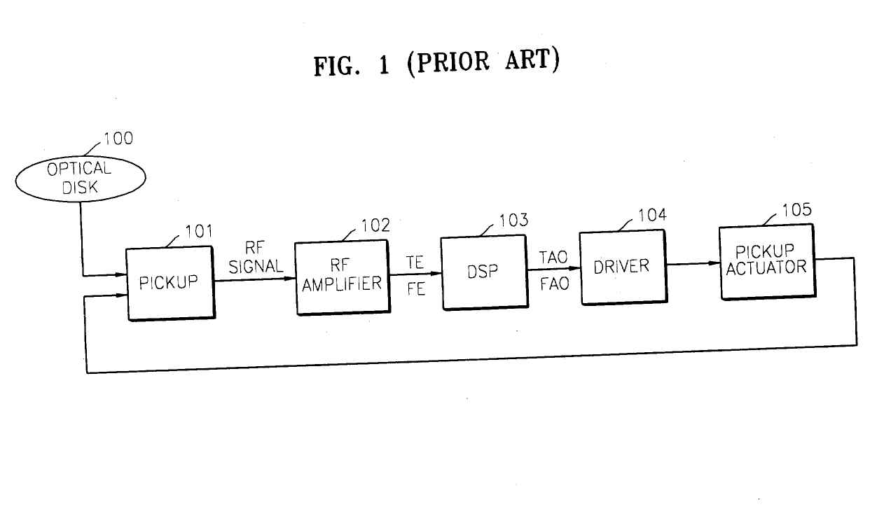

FIG. 2 is a block diagram showing the configuration of an apparatus deleting noise according to an embodiment of the present invention;

FIG. 3 is a block diagram showing the configuration of an apparatus deleting noise, according to another embodiment of the present invention;

FIGS. 4A through 4D show waveform diagrams used to describe an apparatus and a method of deleting noise; and

FIG. 5 is a flow chart showing operations of a method of deleting noise according to the present invention.

### DETAILED DESCRIPTION OF THE PREFERRED EMBODIMENTS

The present invention is described with reference to the accompanying drawings.

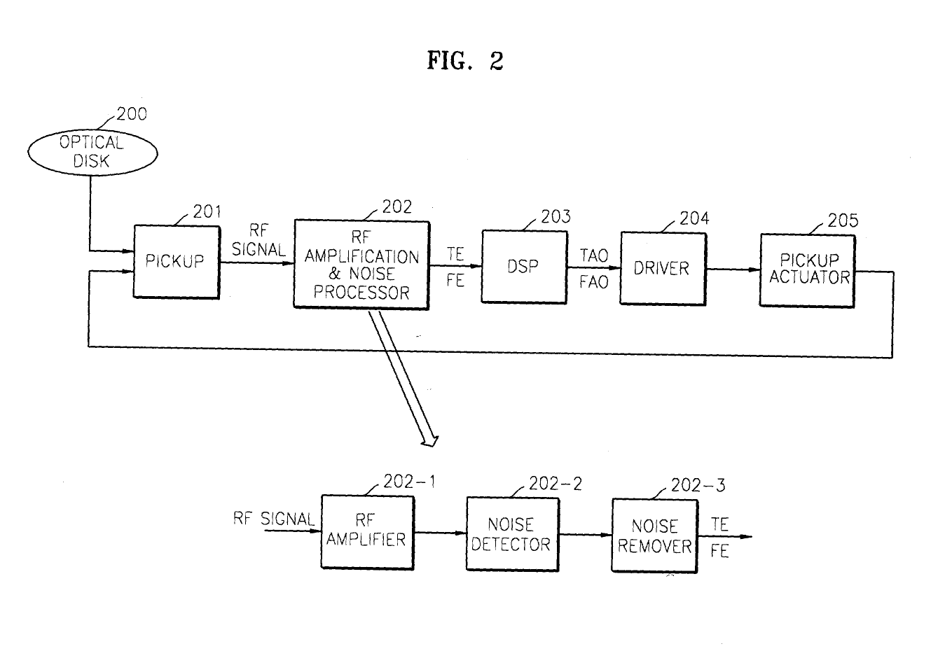

FIG. 2 is a block diagram showing the configuration of an apparatus deleting noise according to an embodiment of the present invention. The apparatus uses an optical disk 200, and includes a pickup 201, an RF amplification and noise processor 202, a DSP (digital signal processor) 203, a driver 204, and a pickup actuator 205. The RF amplification and noise processor 202 comprises an RF amplifier 202-1, a noise detector 202-2, and a noise remover 202-3.

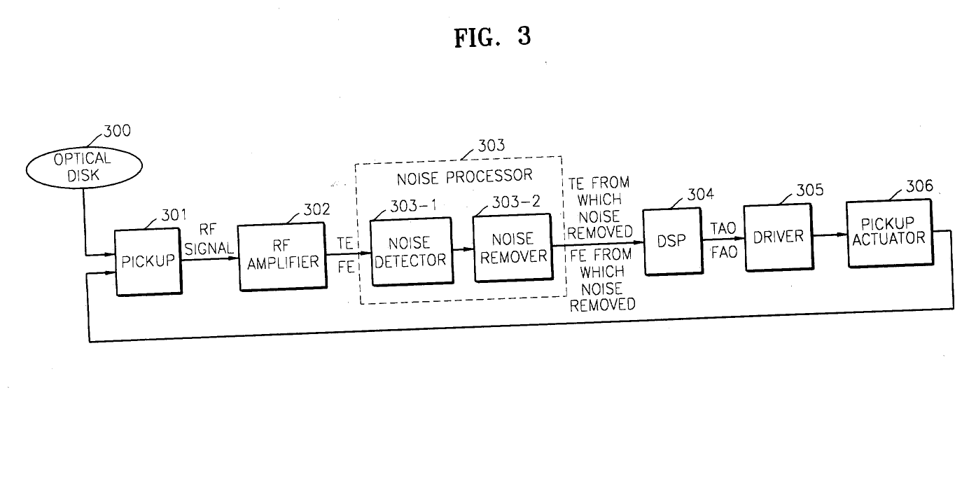

FIG. 3 is a block diagram showing the configuration of an apparatus deleting noise while operating an optical disk 300 according to another embodiment of the present invention, comprising, a pickup 301, an RF amplifier 302, a noise processor 303, a DSP 304, a driver 305, and a pickup actuator 306. The noise processor 303 comprises a noise detector 303-1, and a noise remover 303-2.

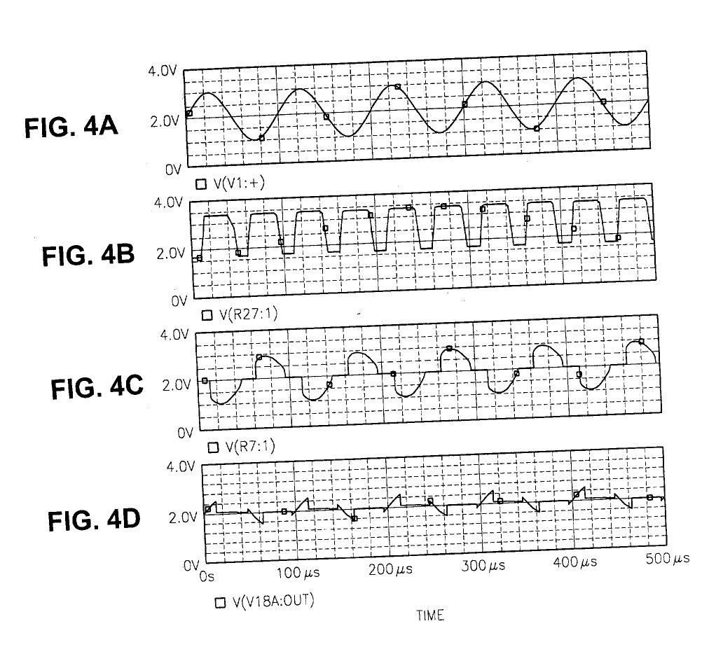

FIGS. 4A through 4D show waveform diagrams used to describe an apparatus and a method of removing noise where FIG. 4A denotes a detected first error signal, FIG. 4B denotes a switch-on signal, FIG. 4C denotes a second error signal that is produced from an inversed first error signal when the switch-on signal is in an “on” state and is null or at a reference voltage when the switch-on signal is in an “off” state, and FIG. 4D denotes a final output signal, referred to as the third error signal, resulting from a combination of the detected first error signal of FIG. 4A and the second error signal of FIG. 4C.

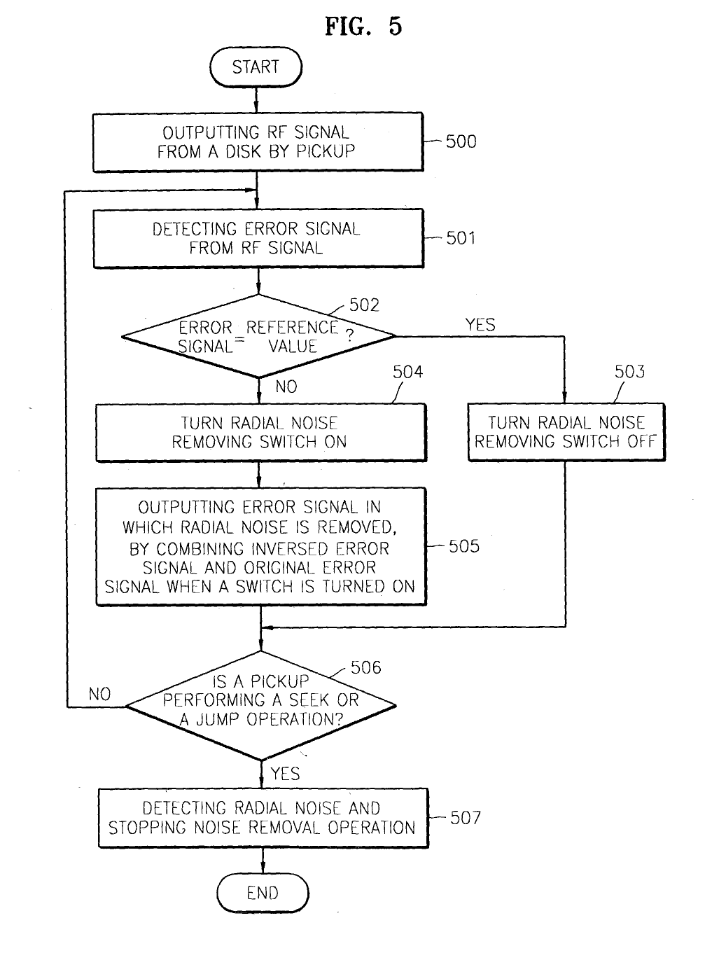

FIG. 5 is a flow chart showing operations of a method of deleting noise that comprises outputting RF signals from a disk by a pickup in operation 500, detecting a first error signal from the RF signal in operation 501, determining if the first error signal is the same as a reference value in operation 502, turning off a radial noise removing switch in operation 503 if the first error signal equals the reference value in operation 502, turning on the radial noise removing switch if the first error signal is not equal to the reference value in operation 504, outputting an error signal from which radial noise is removed by combining the first error signal with a second error signal, the second error signal being null when the noise removing switch is off and an inversed first error signal when the radial noise removing switch is on, in operation 505, determining if a pickup is in a seek operation or a jump operation in operation 506 after operations 503 and 505, and stopping detecting and removing radial noise in operation 507 if the pickup is performing the seek or the jump operation in operation 506. The detecting of the first error signal from the RF signal in operation 501 is performed again if the pickup is not performing the seek or the jump operation in operation 506.

Referring to FIGS. 2 through 5, the present invention now will be described in detail.

In an embodiment shown in FIG. 2, the noise processor is included inside the RF amplifier. When the optical disk 200 is reproduced, RF signals which are reflected from the optical disk 200 by a pickup 201 are input to an RF amplification and noise processor 202. The RF signals output from the pickup 201 are amplified by the RF amplifier 202-1 and input to the noise detector 202-2.

The noise detector 202-2 detects an error signal, referred to as the first error signal, (tracking error signal and/or a focus error signal) from the amplified RF signal. The amplified first error signal is shown in FIG. 4A. The noise detector 202-2 compares the detected first error signal with a reference value and, if the detected first error signal is not equal to the reference value, determines that the first error signal includes radial noise.

The noise remover 202-3 removes radial noise included in an error signal according to a noise detection signal which is output from the noise detector 202-2. The noise remover 202-3 comprises a radial noise removing switch (not shown) to remove radial noise. The radial noise removing switch operates if an error signal is not equal to the reference value and does not operate if the error signal is equal to the reference value. If a reference value of an error signal in FIG. 4A is considered to be 2±1V, and an error signal is not equal to the reference value, i.e., 2±1V, the radial noise removing switch is turned on, and a switch output signal such as that shown in FIG. 4B is generated. When the radial noise removing switch is turned on, the noise remover 202-3 produces a second error signal, which is maintained at a reference voltage when the switch signal is off and is an inversed first error signal when the switch signal is on, as shown in FIG. 4C. A composite third error signal of the signals of FIG. 4C and FIG. 4A, i.e., the signal shown in FIG. 4D, is output from the noise remover 202-3 and becomes a final output signal from which a composite signal is removed. The error signal which is finally output can be a tracking error signal or a focus error signal.

The error signal output from the noise remover 203-3, and from which noise is removed, is input to the DSP 203. The DSP 203 processes the error signal into a signal controlling operations of a servo and outputs the signal as a tracking actuator out (TAO) signal and a focus actuator out (FAO) signal. The driver 204 outputs pulse width modulated TAO and FAO signals which are input to move a pickup actuator 205. If the pickup 201 performs a seek or a jump operation, the noise detector 202-2 and the noise remover 203-3 do not operate.

The second embodiment where a noise processor is outside the RF amplifier now will be described.

When the optical disk 300 is reproduced, RF signals are reflected from the optical disk 300 by a pickup 301 and are input to an RF amplifier 302. The RF amplifier 302 amplifies the input RF signals and outputs them to a noise processor 303.

The noise detector 303-1 of the noise processor 303 detects a first error signal from the amplified RF signal, which is shown in FIG. 4A. The noise detector 303-1 compares the detected first error signal and a reference value and determines that the first error signal includes radial noise if the detected first error signal is not equal to the reference value.

The noise remover 303-2 removes radial noise included in the first error signal according to a noise detection signal which is output from the noise detector 303-1. The noise remover 302-2 comprises a radial noise removing switch (not shown) that is used to remove radial noise. The radial noise removing switch operates if the first error signal is not equal to a reference value and does not operate if the first error signal is equal to the reference value. If the reference value of the error signal shown in FIG. 4A is 2±1V, and the first error signal is not equal to the reference value, the radial noise removing switch is turned on, and a switch output signal such as that shown in FIG. 4B is generated. When the radial noise removing switch is turned on, the noise remover 303-2 combines an inversed first error signal shown in FIG. 4C, with the first error signal detected in the noise detector 303-1 and illustrated in FIG. 4A. A composite error signal of the signals of FIG. 4C and FIG. 4A, or FIG. 4D is output from the noise remover 303-2, and becomes a final output signal (third error signal) from which a composite signal is removed. The error signal which is finally output in FIG. 4D can be a tracking error signal or a focus error signal.

The error signal is forwarded to the noise remover which removes noise from the error signal to produce an error signal output, which is then input to the DSP 304. The DSP 304 processes the noiseless error signal from controlling operations of a servo, and outputs a tracking actuator out signal (TAO) and a focus actuator out signal (FAO) to control operations of a servo. The driver 305 outputs pulse width modulated TAO and FAO signals which move the pickup actuator 306. If the pickup 301 performs a seek or a jump operation, the noise processor 303 does not operate.

A method of removing noise will now be described.

An RF signal is output from an optical disk by a pickup and amplified in operation 500. A first error signal (a tracking error signal or a focus error signal) is detected from the amplified RF signal in operation 501. The detected first error signal is shown in FIG. 4A. The method determines whether the detected error signal is the same as a reference value in operation 502.

If the detected error signal is the same as the reference value, the detected error signal does not include radial noise, and a radial noise switch is turned off in operation 503. If the detected first error signal is not the same as the reference value, in other words, if the detected first error signal is more or less than the reference value, the detected first error signal includes radial noise, and the radial noise removing switch is turned on in operation 504. In particular, if the reference value of the first error signal in FIG. 4A is considered to be 2±1V, and the first error signal is not equal to the reference value, the radial noise removing switch is turned on, and a switch output signal such as that shown in FIG. 4B is generated.

A third error signal is output by combining the initially detected first error signal with a second error signal, in operation 505. The second error signal is an inverted first error signal when the switch-on signal is on and the second error signal is null or a reference voltage when the switch is turned off. The second error signal, i.e., the signal shown in FIG. 4C, and the initially detected first error signal in FIG. 4A are combined into the third error signal, which is a final output signal as illustrated in FIG. 4D, from which radial noise is removed. The third error signal that is finally output, i.e., the signal of FIG. 4D, can be a tracking error signal or a focus error signal.

The third error signal from which noise is removed is processed into a signal controlling the operations of a servo and moving a pickup actuator. Operations 502 through 504 detecting and removing radial noise are stopped in operation 507 if the pickup performs a seek or a jump operation.

The apparatus removing noise in the present invention is designed to detect and remove noise by comparing the voltage of a detected error signal with a reference voltage. However, it is also possible to detect and remove noise by comparing the phase of a detected error signal with that of a reference phase, or by comparing the frequency of a detected error signal with that of a reference frequency.

As described above, according to the present invention, it is possible to reduce the time needed compensating any tilt by determining the initial movement direction of a tilt driver before compensating a tilt, and minimize an effect on a reproducer during tilt compensation.

As described above, the present invention solves the problems of a focus drop in a focus servo which can cause a pickup lens to be confined to a right or left side in a tracking servo, by detecting and removing radial noise from the RF signals which are output from an optical disk.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An apparatus removing noise from a high-frequency signal output by a pickup in an optical recording medium driver, the apparatus comprising:
a noise processor detecting a first error signal from the high-frequency signal when the optical recording medium is reproduced, and removing noise included in the first error signal; and
a signal processor outputting a pickup motion signal that moves the pickup by using the first error signal from which noise is removed.

2. The apparatus of claim 1, wherein the noise processor comprises:
a high-frequency amplifier amplifying the high-frequency signal when the optical recording medium is reproduced;
a noise detector detecting the first error signal from the amplified high-frequency signal and determining if there is noise in the first error signal by comparing the first error signal with a reference value; and
a noise remover turning on a noise removing switch to produce a switch-on signal if the first error signal is not equal to the reference value and outputting a third error signal from which noise is removed, by combining the first error signal with a second error signal, the second error signal being a reference voltage level when the switch-on signal is off and an inversed first error signal when the switch-on signal is on.

3. The apparatus of claim 2, wherein the noise detector and the noise remover do not operate if the pickup performs a seek or a jump operation.

4. An apparatus removing noise in a high-frequency signal output by a pickup in an optical recording medium driver, the apparatus comprising:
an amplifier amplifying the high-frequency signal when an optical recording medium is reproduced;
a noise processor detecting an error signal from the amplified high-frequency signal and removing noise included in the error signal; and
a signal processor outputting a pickup motion signal to move the pickup by using the error signal from which noise is removed.

5. The apparatus of claim 4, wherein the noise processor comprises:
a noise detector detecting a first error signal from the amplified high-frequency signal and determining if there is noise in the first error signal by comparing the detected first error signal with a reference value; and
a noise remover turning on a noise removing switch removing noise and producing a switch-on signal if the first error signal is not equal to a reference value and outputting a third error signal produced by combining the first error signal with a second error signal, the second error signal being a reference voltage level when the switch-on signal is off and an inversed first error signal when the switch-on signal is on.

6. The apparatus of claim 5, wherein the noise detector and the noise remover do not operate if the pickup performs a seek or a jump operation.

7. A method of removing noise in a high-frequency signal output by a pickup of an optical recording medium, the method comprising:
detecting an error signal from the high-frequency signal when an optical recording medium is reproduced and removing noise included in the error signal; and
processing the error signal from which noise is removed into a pickup motion signal to move the pickup and outputting the processed signal.

8. The method of claim 7, wherein the detecting the error signal and the removing the noise comprises:
amplifying the high-frequency signal when the optical recording medium is reproduced;
detecting a first error signal from the amplified high-frequency signal and determining if there is noise in the first error signal by comparing the first error signal with the reference value;
turning on a noise removing switch to produce a switch-on signal if the first error signal is not equal to a reference value; and
outputting a third error signal from which noise is removed, by combining the first error signal with a second error signal, the second error signal being a reference voltage when the switch-on signal is off and an inversed first error signal when the noise removing switch is turned on.

9. The method of claim 8, wherein the detecting the first error signal, the turning on the noise removing switch, and the outputting of the third error signal are not performed when the pickup performs a seek or a jump operation.

10. A method of removing optical media reproduction noise, comprising:
producing a switch-on signal if there is noise in a first error signal;
combining the first error signal with a second error signal, the second error signal being a reference voltage when the switch-on signal is off and an inverted first error signal when the switch-on signal is on, to produce a third error signal; and
processing the third error signal to produce a pickup correction signal.

11. The method of claim 10, further comprising:
comparing the first error signal with a reference value;
determining that there is noise in the first error signal if the first error signal is not equal to the reference value.

12. The method of claim 11, further comprising moving a pickup in response to the pickup correction signal.

13. The method of claim 10, further comprising:
amplifying a high-frequency signal from a pickup to produce an amplified output signal; and
detecting the first error signal in the amplified output signal.

14. The method of claim 11, wherein the comparing includes comparing a phase of the reference signal to a phase of the first error signal.

15. The method of claim 11, wherein the comparing includes comparing a frequency of the reference signal to a frequency of the first error signal.

16. The method of claim 10, further comprising triggering a noise switch to produce the inverse of the first error signal if the first error signal does not equal the reference value.

17. The method of claim 10, further comprising detecting the first error signal.

18. The method of claim 10, wherein:
the third error signal includes a tracking error signal; and
the processing the third error signal includes processing the tracking error signal to correct a tracking error.

19. The method of claim 10,
wherein the third error signal includes a focus error signal; and
the processing the third error signal includes processing the focus error signal to correct a focus error.
